(19) United States
(12) Patent Application Publication
(10) Pub. No.: US 2025/0390807 A1
(43) Pub. Date: Dec. 25, 2025

(54) ESTABLISHING A MULTI-CLOUD ENVIRONMENT BY SOLVING A SHORTEST PATH PROBLEM

(71) Applicant: International Business Machines Corporation, Armonk, NY (US)

(72) Inventors: Takayuki Osogami, Yamato-shi (JP); Hirota Kinoshita, Tokyo (JP)

(21) Appl. No.: 18/748,389

(22) Filed: Jun. 20, 2024

(51) Int. Cl. G06Q 10/047; H04W 76/10

(52) U.S. Cl. CPC G06Q 10/047; H04W 76/10

(57) ABSTRACT

Described are techniques for establishing a multi-cloud environment. A declared type cᵢ is received from a participant i (e.g., cloud buyer) corresponding to cost parameters. The allocation of tasks among the participants (e.g., cloud buyers, cloud providers) is obtained by solving an optimization problem. A graph of nodes and edges is then constructed, where the nodes include a super node and standard nodes corresponding to the possible types of the participant i. Payment from the participant i to the central broker involving the allocation of tasks among the participants is determined corresponding to the shortest path distance from the super node to cᵢ. A multi-cloud environment with cloud providers and cloud buyers is then created based on the allocation of the tasks among the participants and based on the payment between the central broker and the cloud buyers/cloud providers.

### TECHNICAL FIELD

The present disclosure relates generally to a multi-cloud environment.

### BACKGROUND

Multi-cloud is an infrastructure approach that includes a combination of two or more cloud platforms. These platforms may be public or private, although most multi-cloud environments are comprised of at least two different public cloud platforms. Multi-cloud can also (but not necessarily) include on-premise compute, networking, and storage that integrate and work together with the cloud services.

### SUMMARY

In one embodiment of the present disclosure, a computer-implemented method for establishing a multi-cloud environment comprises receiving a declared type cᵢ from a participant i corresponding to cost parameters. The method further comprises constructing a graph of nodes and edges, where the nodes comprise a super node and standard nodes corresponding to possible types of the participant i. The method additionally comprises determining payment from the participant i to a central broker involving an allocation of tasks among participants corresponding to a shortest path distance from the super node to the cᵢ.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a multi-cloud system for practicing the principles of the present disclosure;

FIG. 2 is a diagram of the software components used by the central broker to establish a multi-cloud environment in a computationally efficient manner that can be applied to large multi-cloud markets in accordance with an embodiment of the present disclosure;

FIGS. 3A-3B illustrate that the optimal strategy of each participant i is to truthfully declare its type in accordance with an embodiment of the present disclosure;

FIGS. 4A-4B illustrate that the tasks are allocated in a manner that the total cost of processing those tasks is minimized in accordance with an embodiment of the present disclosure;

FIG. 5 illustrates that the utility is nonnegative for every participant i in accordance with an embodiment of the present disclosure;

FIG. 6 illustrates an embodiment of the present disclosure of the hardware configuration of the central broker which is representative of a hardware environment for practicing the present disclosure; and

FIG. 7 is a flowchart of a method for establishing a multi-cloud environment in a computationally efficient manner that can be applied to large multi-cloud markets in accordance with an embodiment of the present disclosure.

### DETAILED DESCRIPTION

As stated above, multi-cloud is an infrastructure approach that includes a combination of two or more cloud platforms. These platforms may be public or private, although most multi-cloud environments are comprised of at least two different public cloud platforms. Multi-cloud can also (but not necessarily) include on-premise compute, networking, and storage that integrate and work together with the cloud services.

Many organizations desire a multi-cloud approach to infrastructure because it addresses and helps eliminate some common challenges.

For example, having more than one cloud platform allows organizations to take advantage of the unique features and capabilities of each cloud platform. For instance, one cloud platform might be optimized for application hosting while another cloud platform offers cost-effective, scalable space to store public archives, and so forth.

With a multi-cloud approach, organizations overcome the limitations of vendor lock-in and can access all the different capabilities they need. Using a single-cloud approach, the cloud provider locks the cloud users to not only the features and capabilities of the cloud provider but also pricing and other factors, such as available services and tools.

Another reason enterprises opt for multi-cloud is to comply with data sovereignty and regulations in specific geographic locations. Different regions and countries have different laws, so an organization might need to store customer data from one country, for example, on a cloud platform located there, while other customer data from another region is stored separately.

Multi-cloud can also serve as an effective failover model which can help organizations retain data and keep operations running in the event of a cloud or connection failure. Having multiple copies and backups of critical data on different cloud platforms can mean faster recovery time and better business continuity if their main cloud platform goes down.

Unfortunately, establishing a multi-cloud environment may result in direct economic losses to not only the cloud providers (provides on-demand, scalable computing resources, such as computing power, data storage, or applications over the Internet) but also to at least some of the cloud buyers (purchaser of computing resources provided by the cloud providers). For example, the cloud providers' prices in a multi-cloud environment may cause the cloud buyers to lose money as compared to the prices paid in the single-cloud environment (cloud buyer relies upon one cloud provider to provide computing resources).

As a result, a multi-cloud environment does not necessarily benefit the relevant parties (e.g., cloud providers, cloud buyers), including cloud buyers, thereby lessening the incentive to establish a multi-cloud environment.

Furthermore, in order to establish a multi-cloud environment that benefits relevant parties, information, including confidential information, such as information technology costs and the value of the information technology for the cloud buyers and cloud providers, needs to be obtained. Unfortunately, there is little incentive for the parties to disclose such confidential information.

Currently, a process has been developed that establishes a multi-cloud environment that is beneficial to the relevant parties (e.g., cloud providers, cloud buyers) and inherently includes the incentives for the relevant parties to divulge their confidential information. However, such a process has high computational complexity and can only be applied to small multi-cloud markets that involve only a few participants.

The embodiments of the present disclosure provide a means for establishing a multi-cloud environment in a computationally efficient manner that can be applied to large multi-cloud markets by solving the shortest path problem on a graph that only involves a linear number of nodes to determine the amount of payment among the relevant parties (e.g., cloud buyers, cloud providers), while guaranteeing desirable properties. A cloud provider, as used herein, provides on-demand, scalable computing resources, such as computing power, data storage, or applications over the Internet. A cloud buyer, as used herein, refers to a purchaser of computing resources provided by cloud providers. In one embodiment, the amount of payment among the relevant parties (e.g., cloud providers, cloud buyers) that is beneficial to the relevant parties is established by computing the shortest path distance on a graph whose nodes and edges are defined based on the costs of processing tasks by the participant (cloud providers and cloud buyers). The amount of payment among the relevant participants involves an allocation of tasks among the participants. In one embodiment, the efficient allocation of tasks among the participants is determined by solving an optimization problem, such as an Integer Linear Programming (ILP) problem. A task is an independent piece of work. For example, tasks for cloud buyers could be data extraction, machine learning, etc. Tasks for cloud providers could be storing, computing, etc. Such tasks require a set of resources to be utilized to perform such tasks. Allocation, as used herein, refers to a task of a particular participant (e.g., particular cloud buyer) being provided to a different participant (e.g., particular cloud provider) to be performed and handled. For example, the tasks of a cloud buyer are allocated to one or more particular cloud providers to be handled. A multi-cloud environment is then created with n cloud providers and b cloud buyers based on the allocation of the set of tasks, each of which has m types, where n, b and m are positive integer values, as well as based on the amount of payment among the relevant parties. These and other features will be discussed in further detail below.

In some embodiments of the present disclosure, the present disclosure comprises a computer-implemented method, system, and computer program product for establishing a multi-cloud environment. In one embodiment of the present disclosure, a declared type cᵢ is received from a participant i (e.g., cloud buyer, cloud provider) corresponding to cost parameters. In one embodiment, such a declared type cᵢ corresponds to a function that maps a set of tasks to a cost of processing the set of tasks by the participant i. For example, in a cloud environment, there is a set of cloud providers (also referred to herein as “sellers”), which is denoted by CP. In the scenario in which the participant i corresponds to the cloud buyer, each cloud provider cp∈CP has a set of computational resources it can provide to the cloud buyer to fulfill each of its tasks. For all cloud buyers cb∈CB, it is assumed that each of the cloud buyer's tasks can be implemented either on computational resources provided by one or more of the cloud providers cp∈CP, or on an internal computational infrastructure owned and operated by the cloud buyer. This represents the cost of processing the tasks by the participant i. Cloud buyers pay cloud providers for computational resources they use and have costs associated with the internal computational resources (cost of processing the tasks by the participant i). The efficient allocation of tasks, such as the tasks from the cloud buyers and cloud provider, is then determined, such as by solving an optimization problem, such as an Integer Linear Programming (ILP) problem. A task, as used herein, is an independent piece of work. For example, tasks for the cloud buyers could be data extraction, machine learning, etc. Tasks for the cloud providers could be storing, computing, etc. Such tasks require a set of resources to be utilized to perform such tasks. Allocation, as used herein, refers to a task of a particular participant (e.g., particular cloud buyer) being provided to a different participant (e.g., particular cloud provider) to be performed and handled. A graph of nodes and edges is then constructed that is utilized to determine payment among the participants involving the allocation of tasks among the participants, such as by computing the shortest path distance. In one embodiment, the constructed graph includes nodes and edges, where the nodes and edges are defined based on the costs of processing tasks by the participant i. In one embodiment, the nodes include a super node (designated as *) and standard nodes corresponding to the possible types of the participant i. In one embodiment, there is an edge from the super node * to each of the standard nodes and there is an edge on every ordered pair of standard nodes. In one embodiment, the edge from * to standard node ĉᵢ has weight—ĉᵢ(ϕ*(ĉᵢ, c₋ᵢ)), and the edge from standard node

$${\hat{c}}_{i} to {\hat{c}}_{i}^{′} has weight - {\hat{c}}_{i} ( {ϕ}^{★} ( {\hat{c}}_{i} , {c}_{- i} ) ) + {\hat{c}}_{i} ( {ϕ}^{★} ( {\hat{c}}_{i}^{′} , {c}_{- i} ) ) ,$$

where ϕ*(c)∈argmin_{Φ}{Σᵢcᵢ(Φ)}, and where cᵢ(Φ) denotes the cost of participant i to process the tasks allocated to i with allocation Φ. Payment from the participant i who has declared type cᵢ to the central broker is determined corresponding to the shortest path distance from the super node * to cᵢ. In one embodiment, the shortest path distance is computed from the super node * to cᵢ by finding a path from the super node * to cᵢ that minimizes the sum of the weights of its edges. In one embodiment, Dijkstra's algorithm is utilized for finding such a shortest path distance. A multi-cloud environment with cloud providers and cloud buyers is then created based on the allocation of the set of tasks as well as based on the payment between the central broker and the cloud providers and the payment between the central broker and the cloud buyers. In this manner, a multi-cloud environment is created in a computationally efficient manner that can be applied to large multi-cloud markets.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

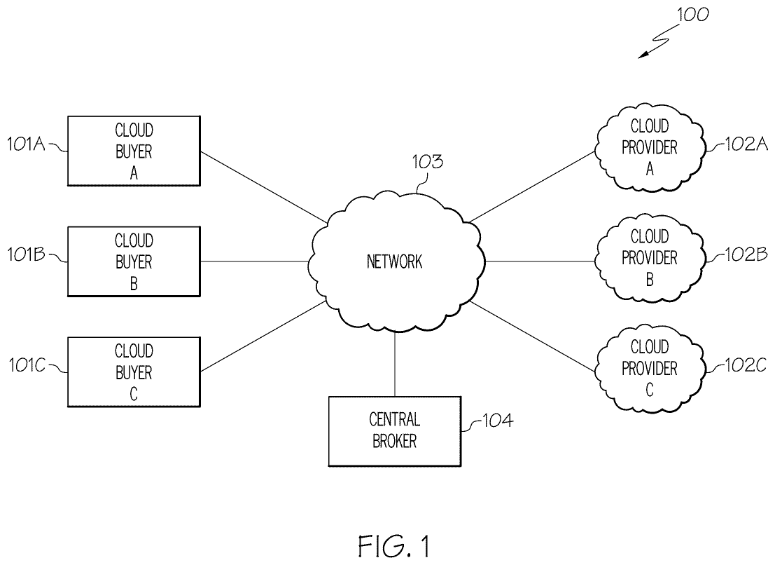

Referring now to the Figures in detail, FIG. 1 illustrates an embodiment of the present disclosure of a multi-cloud system 100 for practicing the principles of the present disclosure. Multi-cloud system 100 includes cloud buyers 101A-101C (identified as “Cloud Buyer A,” “Cloud Buyer B,” and “Cloud Buyer C,” respectively, in FIG. 1) connected to cloud providers 102A-102C (identified as “Cloud Provider A,” “Cloud Provider B,” and “Cloud Provider C,” respectively, in FIG. 1) via a network 103. Cloud buyers 101A-101C, may collectively or individually be referred to as cloud buyers 101 or cloud buyer 101, respectively. Cloud providers 102A-102C may collectively or individually be referred to as cloud providers 102 or cloud provider 102, respectively.

A cloud buyer 101, as used herein, refers to a user (“cloud buyer”) accessing computing resources from cloud providers 102. While FIG. 1 depicts three cloud buyers 101, multi-cloud system 100 may include any number of cloud buyers 101.

A cloud provider 102, as used herein, refers to the operating system and hardware of a server in an Internet-based data center. It allows software and hardware products to co-exist remotely and at scale. While FIG. 1 depicts three cloud providers 102, multi-cloud system 100 may include any number of cloud providers 102.

In one embodiment, cloud providers 102 may correspond to various types, such as public cloud platforms, private cloud platforms or hybrid cloud platforms. Public cloud platforms are third-party providers that deliver computing resources over the Internet. Examples include Amazon Web Services® (AWS®), Google Cloud® Platform, Alibaba®, Microsoft® Azure®, and IBM Bluemix®. A private cloud platform is exclusive to a single organization. Typically, a private cloud platform resides in an on-site data center or hosted by a third-party service provider. A hybrid cloud platform is a combination of public and private cloud platforms. Data and applications move seamlessly between the two.

In one embodiment, cloud provider 102 allows organizations to create cloud-native applications, test and build applications, and store, back up, and recover data. It also allows organizations to analyze data. Organizations can also stream video and audio, embed intelligence into their operations, and deliver software on-demand on a global scale.

In one embodiment, in a multi-cloud environment, cloud buyers 101 may access computing resources from two or more cloud providers 102 at the same time. For example, cloud buyer 101A may access cloud provider 102A to use AWS® for data storage, access cloud provider 102B to use the Google Cloud® Platform for development and testing and access cloud provider 102C to use Microsoft® Azure® for disaster recovery.

Furthermore, as discussed above, cloud buyer 101 is connected to cloud providers 102 via a network 103. Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 902.11 standards network, various combinations thereof, etc. Other networks, whose descriptions are omitted here for brevity, may also be used in conjunction with system 100 of FIG. 1 without departing from the scope of the present disclosure.

Additionally, as shown in FIG. 1, multi-cloud system 100 includes a central broker 104 connected to network 103. In one embodiment, central broker 104 is configured to establish a multi-cloud environment (also referred to as a multi-cloud market) that is beneficial to the relevant parties (e.g., cloud providers 102, cloud buyers 101) in a computationally efficient manner that can be applied to large multi-cloud markets by determining the payment of a participant (e.g., cloud buyer 101, cloud provider 102) of a multi-cloud market corresponding to the shortest path distance on a graph whose nodes and edges are defined based on the costs of processing tasks by the participant. A “multi-cloud environment,” as used herein, refers to the setting where cloud providers provide on-demand, scalable computing resources, such as computing power, data storage, or applications over the Internet, and where cloud buyers purchase computing resources provided by the cloud providers.

In one embodiment, central broker 104 determines the efficient allocation of tasks among the participants (e.g., cloud providers 102, cloud buyers 101), such as the tasks from cloud buyers 101 and cloud providers 102, by solving an optimization problem, such as an Integer Linear Programming (ILP) problem. A task is an independent piece of work. For example, tasks for cloud buyers 101 could be data extraction, machine learning, etc. Tasks for cloud providers 102 could be storing, computing, etc. Such tasks require a set of resources to be utilized to perform such tasks.

In one embodiment, central broker 104 determines the amount of payment between central broker 104 and cloud providers 102/cloud buyers 101 involving the allocation of tasks among the participants by computing the shortest path distance. In one embodiment, central broker 104 constructs a graph of nodes and edges that is utilized to determine payment among the participants involving the allocation of tasks among the participants, such as by computing the shortest path distance. In one embodiment, the constructed graph includes nodes and edges, where the nodes and edges are defined based on the costs of processing tasks by the participant i. In one embodiment, the nodes include a super node (designated as *) and standard nodes corresponding to the possible types of the participant i. In one embodiment, there is an edge from the super node * to each of the standard nodes and there is an edge on every ordered pair of standard nodes. In one embodiment, the edge from * to standard node ĉᵢ has weight—ĉᵢ(ϕ*(ĉᵢ, C₋ᵢ)), and the edge from standard node

$${\hat{c}}_{i} to {\hat{c}}_{i}^{′} has weight - {\hat{c}}_{i} ( {ϕ}^{★} ( {\hat{c}}_{i} , {c}_{- i} ) ) + {\hat{c}}_{i} ( {ϕ}^{★} ( {\hat{c}}_{i}^{′} , {c}_{- i} ) ) ,$$

where ϕ*(c)∈argmin_{Φ} {Σᵢcᵢ(Φ)}. Payment from the participant i who has declared type cᵢ to central broker 104 is determined corresponding to the shortest path distance from the super node * to cᵢ. In one embodiment, the shortest path distance is computed from the super node * to cᵢ by finding a path from the super node * to cᵢ that minimizes the sum of the weights of its edges. In one embodiment, Dijkstra's algorithm is utilized for finding such a shortest path distance.

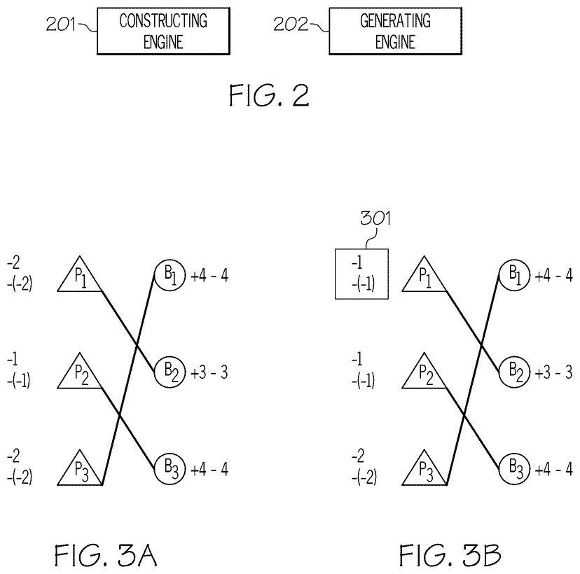

In one embodiment, central broker 104 creates a multi-cloud environment with n cloud providers 102 and b cloud buyers 101 based on the allocation of the set of tasks, each of which has m types, where n, b and m are positive integer values, as well as based on the payment between central broker 104 and cloud providers 102 and the payment between central broker 104 and cloud buyers 101. A discussion regarding central broker 104 establishing such a multi-cloud environment is provided further below in connection with FIGS. 2-5 and 7.

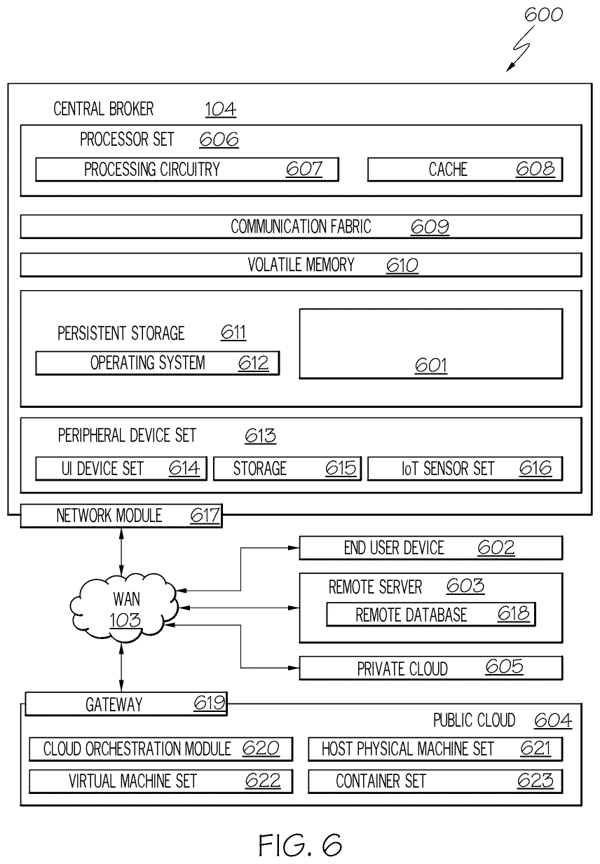

Furthermore, a description of the software components of central broker 104 used for establishing a multi-cloud environment in a computationally efficient manner that can be applied to large multi-cloud markets is provided below in connection with FIG. 2. A description of the hardware configuration of central broker 104 is provided further below in connection with FIG. 6.

System 100 is not to be limited in scope to any one particular network architecture. System 100 may include any number of cloud buyers 101, cloud providers 102, networks 103, and central brokers 104.

A discussion regarding the software components used by central broker 104 to establish a multi-cloud environment in a computationally efficient manner that can be applied to large multi-cloud markets is provided below in connection with FIG. 2.

FIG. 2 is a diagram of the software components used by central broker 104 to establish a multi-cloud environment in a computationally efficient manner that can be applied to large multi-cloud markets in accordance with an embodiment of the present disclosure.

Referring to FIG. 2, in conjunction with FIG. 1, central broker 104 includes constructing engine 201 configured to obtain an efficient allocation of tasks among the participants (e.g., cloud buyers 101, cloud providers 102) by solving an optimization problem, such as an Integer Linear Programming (ILP) problem. A task, as used herein, is an independent piece of work. For example, tasks for cloud buyers 101 could be data extraction, machine learning, etc. Tasks for cloud providers 102 could be storing, computing, etc. Such tasks require a set of resources to be utilized to perform such tasks. Allocation, as used herein, refers to a task of a particular participant (e.g., particular cloud buyer 101) being provided to a different participant (e.g., particular cloud provider 102) to be performed and handled. For example, the tasks of a cloud buyer 101 are allocated to one or more particular cloud providers 102 to be handled.

In one embodiment, such an allocation of tasks may be expressed using the following formula. Let ĉᵢ(Φ) denote the cost of participant i to process the tasks allocated to i with allocation Φ. The tasks of participant i, such as cloud buyer 101, that are not allocated to any of the cloud providers 102 are allocated to i, which is represented in the following formula:

$${ϕ}^{★} ( c ) ∈ {argmin}_{Φ} \{ {\sum }_{i} {c}_{i} ( Φ ) \}$$

In one embodiment, constructing engine 201 obtains the efficient allocation of tasks among the participants by maximizing the benefit among the participants (i.e., cloud buyers 101, cloud providers 102) by solving an optimization program, such as an Integer Linear Programming (ILP) problem. If all the participants disclose truthfully, the benefit maximization problem (N, M) can be formulated as an Integer Linear Programming (ILP) problem which is an NP-hard problem.

$$Π , ( , ) \text{?} maximize 𝒲 ( , ) = \text{?} \qquad ( 1 )$$

$$Subject to$$

$$\text{?} = \text{?} ∀ k ϵ \qquad ( 2 )$$

$$\text{?} [ 0 , 1 ] ∀ \text{?} ϵ \qquad ( 3 )$$

$${z}_{jk} ϵ [ 0 , 1 \text{?} ] ∀ j ϵ , k ϵ \qquad ( 4 )$$

$$\text{?} \text{indicates text missing or illegible when filed}$$

where N is the number of cloud buyers 101 and M is the number of cloud providers 102.

In the above formulation, in Equation (1) W(N, M), the benefit among the participants is the objective to be maximized. The first constraint, i.e., Equation (2), specifies that the number of tasks to be allocated should be equal to number of offered resources in the final allocation. Equations (3) and (4) depict that the decision variables xᵢ and zjk should be integers. xᵢ is 1 if participant i (e.g., cloud buyer 101, cloud provider 102) wins, otherwise it is 0. zjk denotes the allocated quantity of the kth type of cloud resource VM of cloud provider j and it should not exceed the total number of VMs of the kth type at cloud provider j.

In one embodiment, constructing engine 201 constructs a graph of nodes and edges that is utilized to obtain payment among the participants involving the allocation of tasks among the participants, such as by computing the shortest path distance.

In one embodiment, constructing engine 201 constructs such a graph by receiving a declared type cᵢ from a participant I (e.g., cloud buyer 101, cloud provider 102) corresponding to cost parameters. In one embodiment, the declared type cᵢ corresponds to a function that maps a given set of tasks to a cost of processing the tasks by the participant i. For example, in a cloud environment, there is a set of cloud providers 102 (also referred to herein as “sellers”), which is denoted by CP. In the scenario in which the participant i corresponds to cloud buyer 101, each cloud provider cp∈CP has a set of computational resources it can provide to cloud buyers 101 to fulfill each of its tasks. For all cloud buyers 101 cb∈CB, it is assumed that each of the cloud buyer's tasks can be implemented either on computational resources provided by one or more of the cloud providers 102 cp∈CP, or on an internal computational infrastructure owned and operated by cloud buyer 101. This represents the cost of processing the tasks by the participant i. Cloud buyers 101 pay cloud providers 102 for computational resources they use and have costs associated with the internal computational resources (cost of processing the tasks by the participant i).

In another example, in which the participant i corresponds to cloud provider 102, cloud providers 102 have costs for providing the computational resources to cloud buyers 101 (cost of processing the tasks by provider i). In one embodiment, the cost of cloud buyer 101 cb for providing the computational resources for a subset of tasks T′⊆T_{cb} is modeled by a function F_{cb}: 2^{Tcb}→R⁺, and the cost of cloud provider 102 cp∈CP for providing the set of computational resources for a subset of tasks T′⊆T=U_{cb∈CB}T_{cb} by a function C_{cp}:2^{T}→R⁺.

In one embodiment, given the declared types cᵢ, constructing engine 201 finds the amount of payment between central broker 104 and cloud providers 102 and the amount of payment between central broker 104 and cloud buyers 101 involving the allocation of tasks among the participants using a constructed graph as discussed below.

In one embodiment, for each participant i, payment from participant i to central broker 104 is determined based on constructing a graph of nodes and edges as discussed below. By determining such payments, a multi-cloud environment can be established in a computationally efficient manner that can be applied to large multi-cloud markets.

In one embodiment, using such declared types cᵢ from participants i, constructing engine 201 constructs a graph of nodes and edges, where the nodes and edges are defined based on the costs of processing tasks by the participant i. In one embodiment, the nodes include a super node (designated as *) and standard nodes corresponding to the possible types of the participant i. In one embodiment, there is an edge from the super node * to each of the standard nodes and there is an edge on every ordered pair of standard nodes. The edge from * to standard node ĉᵢ has weight −ĉᵢ (ϕ*(ĉᵢ, c₋ᵢ)), and the edge from standard node

$${\hat{c}}_{i} to {\hat{c}}_{i}^{′} has weight - {\hat{c}}_{i} ( {ϕ}^{★} ( {\hat{c}}_{i} , {c}_{- i} ) ) + {\hat{c}}_{i} ( {ϕ}^{★} ( {\hat{c}}_{i}^{′} , {c}_{- i} ) ) .$$

In one embodiment, constructing engine 201 constructs such a graph using various software tools which can include, but are not limited to, Ripjar®, Graphviz, Plotly®, NetworkX, Gephi, etc.

In one embodiment, constructing engine 201 determines the payment from the participant i to central broker 104 corresponding to the shortest path distance from the super node * to cᵢ, where cᵢ is the type declared by the participant i, and where ϕ*(c)∈argmin_{Φ}{Σᵢcᵢ(Φ)}.

In one embodiment, constructing engine 201 computes the shortest path distance from the super node * to cᵢ by finding a path from the super node * to cᵢ that minimizes the sum of the weights of its edges. In one embodiment, constructing engine utilizes Dijkstra's algorithm for finding such a shortest path distance.

In one embodiment, constructing engine 201 implements Dijkstra's algorithm using the following steps: (1) marking the ending vertex with a distance of zero, which is designated as the current vertex; (2) finding all vertices leading to the current vertex and calculating their distances to the end; (3) marking the current vertex as visited; and (4) marking the vertex with the smallest distance as the current vertex, and repeating from step 2.

Based on determining the payment from the participant i to central broker 104 using such a constructed graph, various desirable properties are guaranteed. For example, it is guaranteed that the optimal strategy of each participant i is to truthfully declare its type, which gives a clear course of action for the participant i as illustrated in FIGS. 3A-3B.

FIGS. 3A-3B illustrate that the optimal strategy of each participant i is to truthfully declare its type in accordance with an embodiment of the present disclosure.

As shown in FIG. 3A, cloud providers 102 are represented by P₁, P₂, and P₃. Cloud buyers 101 are represented by B₁, B₂, and B₃. Each participant's value on the allocation (top value for cloud providers 102 and left numbers for cloud buyers 101) is shown in FIG. 3A. Furthermore, each participant's payment to central broker 104 (bottom value for cloud providers 102 and right numbers for cloud buyers 101) is shown in FIG. 3A. As illustrated in FIG. 3A, each participant's value of the allocation and their payment to central broker 104 add up to a nonnegative utility (measure of how much benefit a party receives or is expected to receive).

As illustrated in FIG. 3B, cloud provider P₁ could gain nothing even if such a cloud provider 102 declared a false type, in which case his payment to central broker 104 would increase accordingly as shown in element 301.

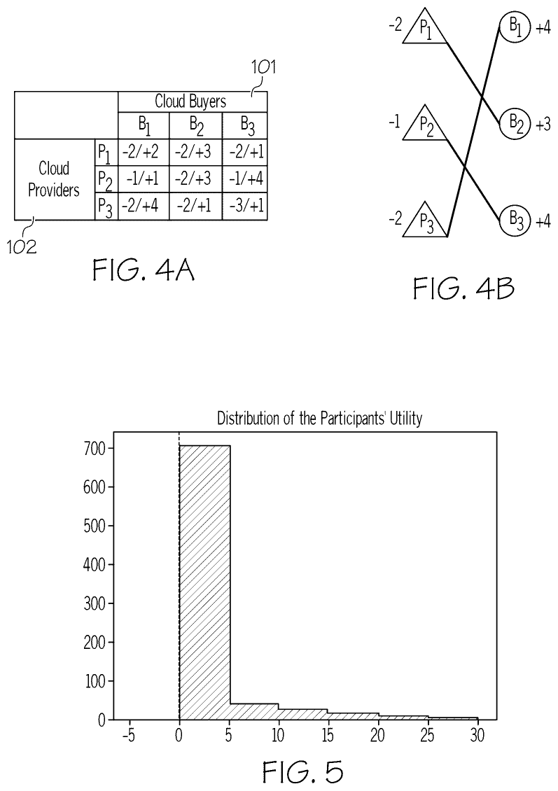

Another desirable property that is guaranteed based on determining the payment from the participant i to central broker 104 using such a constructed graph is that the tasks are allocated in a manner that the total cost of processing those tasks is minimized as illustrated in FIGS. 4A-4B.

FIGS. 4A-4B illustrate that the tasks are allocated in a manner that the total cost of processing those tasks is minimized in accordance with an embodiment of the present disclosure.

Referring to FIG. 4A, FIG. 4A illustrates the cost/profit of each contract under the declaration between cloud providers 102 (identified as P₁, P₂, and P₃) and cloud buyers 101 (identified as B₁, B₂, and B₃). As shown in FIG. 4A, the cost/profit between cloud provider P₁ and cloud buyer B₁ is −2/+2. In another example, the cost/profit between cloud provider P₁ and cloud buyer B₂ is −2/+3 and so forth.

By determining the payment from the participant i to central broker 104 corresponding to the shortest path distance from the super node * to cᵢ, the total cost of processing the tasks is minimized as illustrated in FIG. 4B.

Referring to FIG. 4B, the efficient allocation of the tasks between cloud providers 102 and cloud buyers 101 has a maximum total value of 6. For instance, based on the cost/profit of the contracts between cloud provider P₁ and cloud buyers B₁, B₂, and B₃, the contract between cloud provider P₁ and cloud buyer B₂ has the maximum cost/profit as shown in FIG. 4B. In another example, based on the cost/profit of the contracts between cloud provider P₂ and cloud buyers B₁, B₂, and B₃, the contract between cloud provider P₂ and cloud buyer B₃ has the maximum cost/profit as shown in FIG. 4B. In a further example, based on the cost/profit of the contracts between cloud provider P₃ and cloud buyers B₁, B₂, and B₃, the contract between cloud provider P₃ and cloud buyer B₁ has the maximum cost/profit as shown in FIG. 4B. As further shown in FIG. 4B, the total cost among the cloud providers P₁, P₂, and P₃ equals −5; whereas, the total profit among the cloud buyers, B₁, B₂, and B₃ equals +11 thereby resulting in a maximum total value of 6.

Another desirable property that is guaranteed based on determining the payment from the participant i to central broker 104 using such a constructed graph is that the utility (measure of how much benefit a party receives or is expected to receive, which may correspond to payment received—cost) is nonnegative for every participant i as illustrated in FIG. 5.

FIG. 5 illustrates that the utility is nonnegative for every participant i in accordance with an embodiment of the present disclosure.

Referring to FIG. 5, FIG. 5 is a graph illustrating the distribution of the participants' utility over random multi-cloud market instances. As shown in FIG. 5, such a utility is nonnegative for every participant i.

A further desirable property that is guaranteed based on determining the payment from the participant i to central broker 104 using such a constructed graph is that when a unique allocation minimizes the total cost (i.e., |argmin_{Φ}{Σᵢcᵢ(Φ)}|=1), the revenue of central broker 104 cannot be made larger without sacrificing the other desirable properties.

Referring to FIG. 2, central broker 104 further includes generating engine 202 configured to create a multi-cloud environment with n cloud providers 102 and b cloud buyers 101 based on the allocation of the set of tasks, each of whom has m types, where n, b and m are positive integer values, as well as based on the payment between central broker 104 and cloud providers 102 and the payment between central broker 104 and cloud buyers 101. For example, generating engine 202 may create a multi-cloud environment consisting of cloud buyers 101A-101C and cloud providers 102A-102C in which the tasks, such as the tasks of cloud buyers 101A-101C are allocated to be handled by cloud providers 102A-102C. For instance, the tasks of cloud buyer 101A may be handled by cloud providers 102A and 102B, the tasks of cloud buyer 101B may be handled by cloud providers 102B and 102C, and the tasks of cloud buyer 101C may be handled by cloud provider 102A.

Generating engine 202 may utilize various software tools for creating a multi-cloud environment, including, but not limited to, IBM® Hybrid Cloud Mesh, Terraform®, Ansible®, Cloudify, Morpheus®, etc.

In this manner, a multi-cloud environment is created that is beneficial for all participants (e.g., cloud buyers 101, cloud providers 102) in the sense that all participants obtain a higher utility than in a single cloud market by solving the shortest path problem on a graph that only involves a linear number of nodes to determine the amount of payment among the relevant parties (e.g., cloud buyers 101, cloud providers 102) involving the allocation of tasks among the participants, while guaranteeing desirable properties. By determining such payment by solving the shortest path problem, a multi-cloud environment is established in a computationally efficient manner that can be applied to large multi-cloud markets.

A further description of these and other features is provided below in connection with the discussion of the method for establishing a multi-cloud environment in a computationally efficient manner that can be applied to large multi-cloud markets.

Prior to the discussion of the method for establishing a multi-cloud environment in a computationally efficient manner that can be applied to large multi-cloud markets, a description of the hardware configuration of central broker 104 (FIG. 1) is provided below in connection with FIG. 6.

Referring now to FIG. 6, in conjunction with FIG. 1, FIG. 6 illustrates an embodiment of the present disclosure of the hardware configuration of central broker 104 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code (stored in block 601) involved in performing the inventive methods, such as establishing a multi-cloud environment in a computationally efficient manner that can be applied to large multi-cloud markets. In addition to block 601, computing environment 600 includes, for example, central broker 104, network 103, such as a wide area network (WAN), end user device (EUD) 602, remote server 603, public cloud 604, and private cloud 605. In this embodiment, central broker 104 includes processor set 606 (including processing circuitry 607 and cache 608), communication fabric 609, volatile memory 610, persistent storage 611 (including operating system 612 and block 601, as identified above), peripheral device set 613 (including user interface (UI) device set 614, storage 615, and Internet of Things (IoT) sensor set 616), and network module 617. Remote server 603 includes remote database 618. Public cloud 604 includes gateway 619, cloud orchestration module 620, host physical machine set 621, virtual machine set 622, and container set 623.

Central broker 104 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 618. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically central broker 104, to keep the presentation as simple as possible. Central broker 104 may be located in a cloud, even though it is not shown in a cloud in FIG. 6. On the other hand, central broker 104 is not required to be in a cloud except to any extent as may be affirmatively indicated.

Processor set 606 includes one, or more, computer processors of any type now known or to be developed in the future. Processing circuitry 607 may be distributed over multiple packages, for example, multiple, coordinated integrated circuit chips. Processing circuitry 607 may implement multiple processor threads and/or multiple processor cores. Cache 608 is memory that is located in the processor chip package(s) and is typically used for data or code that should be available for rapid access by the threads or cores running on processor set 606. Cache memories are typically organized into multiple levels depending upon relative proximity to the processing circuitry. Alternatively, some, or all, of the cache for the processor set may be located “off chip.” In some computing environments, processor set 606 may be designed for working with qubits and performing quantum computing.

Computer readable program instructions are typically loaded onto central broker 104 to cause a series of operational steps to be performed by processor set 606 of central broker 104 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 608 and the other storage media discussed below. The program instructions, and associated data, are accessed by processor set 606 to control and direct performance of the inventive methods. In computing environment 600, at least some of the instructions for performing the inventive methods may be stored in block 601 in persistent storage 611.

Communication fabric 609 is the signal conduction paths that allow the various components of central broker 104 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 610 is any type of volatile memory now known or to be developed in the future. Examples include dynamic type random access memory (RAM) or static type RAM. Typically, the volatile memory is characterized by random access, but this is not required unless affirmatively indicated. In central broker 104, the volatile memory 610 is located in a single package and is internal to central broker 104, but, alternatively or additionally, the volatile memory may be distributed over multiple packages and/or located externally with respect to central broker 104.

Persistent Storage 611 is any form of non-volatile storage for computers that is now known or to be developed in the future. The non-volatility of this storage means that the stored data is maintained regardless of whether power is being supplied to central broker 104 and/or directly to persistent storage 611. Persistent storage 611 may be a read only memory (ROM), but typically at least a portion of the persistent storage allows writing of data, deletion of data and re-writing of data. Some familiar forms of persistent storage include magnetic disks and solid state storage devices. Operating system 612 may take several forms, such as various known proprietary operating systems or open source Portable Operating System Interface type operating systems that employ a kernel. The code included in block 601 typically includes at least some of the computer code involved in performing the inventive methods.

Peripheral device set 613 includes the set of peripheral devices of central broker 104. Data communication connections between the peripheral devices and the other components of central broker 104 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 614 may include components such as a display screen, speaker, microphone, wearable devices (such as goggles and smart watches), keyboard, mouse, printer, touchpad, game controllers, and haptic devices. Storage 615 is external storage, such as an external hard drive, or insertable storage, such as an SD card. Storage 615 may be persistent and/or volatile. In some embodiments, storage 615 may take the form of a quantum computing storage device for storing data in the form of qubits. In embodiments where central broker 104 is required to have a large amount of storage (for example, where central broker 104 locally stores and manages a large database) then this storage may be provided by peripheral storage devices designed for storing very large amounts of data, such as a storage area network (SAN) that is shared by multiple, geographically distributed computers. IoT sensor set 616 is made up of sensors that can be used in Internet of Things applications. For example, one sensor may be a thermometer and another sensor may be a motion detector.

Network module 617 is the collection of computer software, hardware, and firmware that allows central broker 104 to communicate with other computers through WAN 103. Network module 617 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 617 are performed on the same physical hardware device. In other embodiments (for example, embodiments that utilize software-defined networking (SDN)), the control functions and the forwarding functions of network module 617 are performed on physically separate devices, such that the control functions manage several different network hardware devices. Computer readable program instructions for performing the inventive methods can typically be downloaded to central broker 104 from an external computer or external storage device through a network adapter card or network interface included in network module 617.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 602 is any computer system that is used and controlled by an end user (for example, a customer of an enterprise that operates central broker 104), and may take any of the forms discussed above in connection with central broker 104. EUD 602 typically receives helpful and useful data from the operations of central broker 104. For example, in a hypothetical case where central broker 104 is designed to provide a recommendation to an end user, this recommendation would typically be communicated from network module 617 of central broker 104 through WAN 103 to EUD 602. In this way, EUD 602 can display, or otherwise present, the recommendation to an end user. In some embodiments, EUD 602 may be a client device, such as thin client, heavy client, mainframe computer, desktop computer and so on.

Remote server 603 is any computer system that serves at least some data and/or functionality to central broker 104. Remote server 603 may be controlled and used by the same entity that operates central broker 104. Remote server 603 represents the machine(s) that collect and store helpful and useful data for use by other computers, such as central broker 104. For example, in a hypothetical case where central broker 104 is designed and programmed to provide a recommendation based on historical data, then this historical data may be provided to central broker 104 from remote database 618 of remote server 603.

Public cloud 604 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 604 is performed by the computer hardware and/or software of cloud orchestration module 620. The computing resources provided by public cloud 604 are typically implemented by virtual computing environments that run on various computers making up the computers of host physical machine set 621, which is the universe of physical computers in and/or available to public cloud 604. The virtual computing environments (VCEs) typically take the form of virtual machines from virtual machine set 622 and/or containers from container set 623. It is understood that these VCEs may be stored as images and may be transferred among and between the various physical machine hosts, either as images or after instantiation of the VCE. Cloud orchestration module 620 manages the transfer and storage of images, deploys new instantiations of VCEs and manages active instantiations of VCE deployments. Gateway 619 is the collection of computer software, hardware, and firmware that allows public cloud 604 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 605 is similar to public cloud 604, except that the computing resources are only available for use by a single enterprise. While private cloud 605 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 604 and private cloud 605 are both part of a larger hybrid cloud.

Block 601 further includes the software components discussed above in connection with FIGS. 2-5 to establish a multi-cloud environment in a computationally efficient manner that can be applied to large multi-cloud markets. In one embodiment, such components may be implemented in hardware. The functions discussed above performed by such components are not generic computer functions. As a result, central broker 104 is a particular machine that is the result of implementing specific, non-generic computer functions.

In one embodiment, the functionality of such software components of central broker 104, including the functionality for establishing a multi-cloud environment in a computationally efficient manner that can be applied to large multi-cloud markets, may be embodied in an application specific integrated circuit.

As stated above, multi-cloud is an infrastructure approach that includes a combination of two or more cloud platforms. These platforms may be public or private, although most multi-cloud environments are comprised of at least two different public cloud platforms. Multi-cloud can also (but not necessarily) include on-premise compute, networking, and storage that integrate and work together with the cloud services. Many organizations desire a multi-cloud approach to infrastructure because it addresses and helps eliminate some common challenges. For example, having more than one cloud platform allows organizations to take advantage of the unique features and capabilities of each cloud platform. For instance, one cloud platform might be optimized for application hosting while another cloud platform offers cost-effective, scalable space to store public archives, and so forth. With a multi-cloud approach, organizations overcome the limitations of vendor lock-in and can access all the different capabilities they need. Using a single-cloud approach, the cloud provider locks the cloud users to not only the features and capabilities of the cloud provider but also pricing and other factors, such as available services and tools. Another reason enterprises opt for multi-cloud is to comply with data sovereignty and regulations in specific geographic locations. Different regions and countries have different laws, so an organization might need to store customer data from one country, for example, on a cloud platform located there, while other customer data from another region is stored separately. Multi-cloud can also serve as an effective failover model which can help organizations retain data and keep operations running in the event of a cloud or connection failure. Having multiple copies and backups of critical data on different cloud platforms can mean faster recovery time and better business continuity if their main cloud platform goes down. Unfortunately, establishing a multi-cloud environment may result in direct economic losses to not only the cloud providers (provides on-demand, scalable computing resources, such as computing power, data storage, or applications over the Internet) but also to at least some of the cloud buyers (purchaser of computing resources provided by the cloud providers). For example, the cloud providers' prices in a multi-cloud environment may cause the cloud buyers to lose money as compared to the prices paid in the single-cloud environment (cloud buyer relies upon one cloud provider to provide computing resources). As a result, a multi-cloud environment does not necessarily benefit the relevant parties (e.g., cloud providers, cloud buyers), including cloud buyers, thereby lessening the incentive to establish a multi-cloud environment. Furthermore, in order to establish a multi-cloud environment that benefits relevant parties, information, including confidential information, such as information technology costs and the value of the information technology for the cloud buyers and cloud providers, needs to be obtained. Unfortunately, there is little incentive for the parties to disclose such confidential information. Currently, a process has been developed that establishes a multi-cloud environment that is beneficial to the relevant parties (e.g., cloud providers, cloud buyers) and inherently includes the incentives for the relevant parties to divulge their confidential information. However, such a process has high computational complexity and can only be applied to small multi-cloud markets that involve only a few participants.

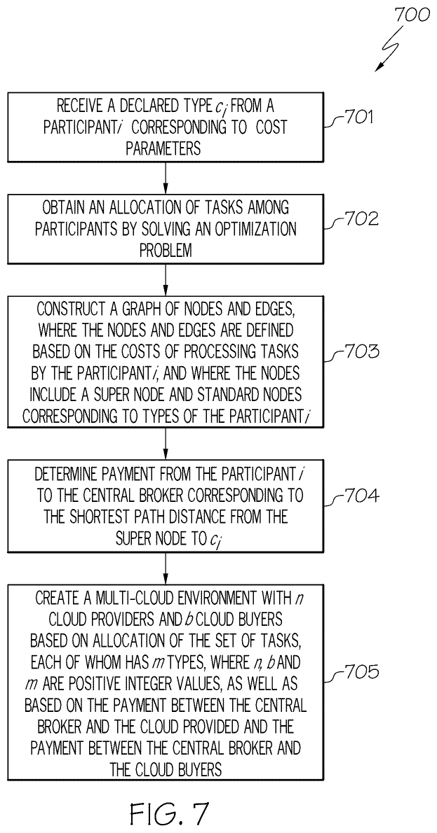

The embodiments of the present disclosure provide a means for establishing a multi-cloud environment in a computationally efficient manner that can be applied to large multi-cloud markets by solving a shortest path problem on a graph that only involves a linear number of nodes to determine the amount of payment among the relevant parties (e.g., cloud providers, cloud buyers), while guaranteeing desirable properties, as discussed below in connection with FIG. 7.

FIG. 7 is a flowchart of a method 700 for establishing a multi-cloud environment in a computationally efficient manner that can be applied to large multi-cloud markets in accordance with an embodiment of the present disclosure.

Referring to FIG. 7, in conjunction with FIGS. 1-6, in operation 701, constructing engine 201 of central broker 104 receives a declared type cᵢ from a participant i (e.g., cloud buyer 101, cloud provider 102) corresponding to cost parameters. In one embodiment, constructing engine 201 of central broker 104 receives a declared type cᵢ corresponding to a function that maps a set of tasks to a cost of processing the tasks by the participant i.

In operation 702, constructing engine 201 of central broker 104 obtains an efficient allocation of tasks among the participants (e.g., cloud buyers 101, cloud providers 102) by solving an optimization problem, such as an Integer Linear Programming (ILP) problem. A task, as used herein, is an independent piece of work. For example, tasks for cloud buyers 101 could be data extraction, machine learning, etc. Tasks for cloud providers 102 could be storing, computing, etc. Such tasks require a set of resources to be utilized to perform such tasks. Allocation, as used herein, refers to a task of a particular participant (e.g., particular cloud buyer 101) being provided to a different participant (e.g., particular cloud provider 102) to be performed and handled. For example, the tasks of a cloud buyer 101 are allocated to one or more particular cloud providers 102 to be handled.

In one embodiment, such an allocation of tasks may be expressed using the following formula. Let cᵢ(Φ) denote the cost of participant i to process the tasks allocated to i with allocation Φ. The tasks of participant i, such as cloud buyer 101, that are not allocated to any of the cloud providers 102 are allocated to i, which is represented in the following formula:

$${ϕ}^{★} ( c ) ∈ {argmin}_{Φ} \{ {\sum }_{i} {c}_{i} ( Φ ) \}$$

In one embodiment, constructing engine 201 obtains the efficient allocation of tasks among the participants by maximizing the benefit among the participants (i.e., cloud buyers 101, cloud providers 102) by solving an optimization program, such as an Integer Linear Programming (ILP) problem. If all the participants disclose truthfully, the benefit maximization problem (N, M) can be formulated as an Integer Linear Programming (ILP) problem which is an NP-hard problem.

$$Π , ( , ) \text{?} maximize 𝒲 ( , ) = \text{?} \qquad ( 1 )$$

$$Subject to$$

$$\text{?} = \text{?} ∀ k ϵ \qquad ( 2 )$$

$$\text{?} [ 0 , 1 ] ∀ \text{?} ϵ \qquad ( 3 )$$

$${z}_{jk} ϵ [ 0 , 1 \text{?} ] ∀ j ϵ \text{?} k ϵ \qquad ( 4 )$$

$$\text{?} \text{indicates text missing or illegible when filed}$$

where N is the number of cloud buyers 101 and M is the number of cloud providers 102.

In the above formulation, in Equation (1) W (N, M), the benefit among the participants is the objective to be maximized. The first constraint, i.e., Equation (2), specifies that the number of tasks to be allocated should be equal to number of offered resources in the final allocation. Equations (3) and (4) depict that the decision variables xᵢ and zjk should be integers. xᵢ is 1 if participant i (e.g., cloud buyer 101, cloud provider 102) wins, otherwise it is 0. zjk denotes the allocated quantity of the kth type of cloud resource VM of cloud provider j and it should not exceed the total number of VMs of the kth type at cloud provider j.

In operation 703, using such declared types cᵢ from participants i, constructing engine 201 of central broker 104 constructs a graph of nodes and edges, where the nodes and edges are defined based on the costs of processing tasks by the participant i, to obtain payment among the participants involving the allocation of tasks among the participants, such as by computing the shortest path distance.

As discussed above, for example, in a cloud environment, there is a set of cloud providers 102 (also referred to herein as “sellers”), which is denoted by CP. In the scenario in which the participant i corresponds to cloud buyer 101, each cloud provider cp∈CP has a set of computational resources it can provide to cloud buyers 101 to fulfill each of its tasks. For all cloud buyers 101 cb∈CB, it is assumed that each of the cloud buyer's tasks can be implemented either on computational resources provided by one or more of the cloud providers 102 cp∈CP, or on an internal computational infrastructure owned and operated by cloud buyer 101. This represents the cost of processing the tasks by the participant i. Cloud buyers 101 pay cloud providers 102 for computational resources they use and have costs associated with the internal computational resources (cost of processing the tasks by the participant i).

In another example, in which the participant i corresponds to cloud provider 102, cloud providers 102 have costs for providing the computational resources to cloud buyers 101 (cost of processing the tasks by provider i). In one embodiment, the cost of cloud buyer 101 cb for providing the computational resources for a subset of tasks T′⊆T_{cb} is modeled by a function F_{cb}: 2^{Tcb}→R⁺, and the cost of cloud provider 102 cp∈CP for providing the set of computational resources for a subset of tasks T′⊆T=U_{cb∈CB}T_{cb} by a function C_{cp}: 2^{T}→R⁺.

In one embodiment, the nodes of the constructed graph include a super node (designated as *) and standard nodes corresponding to the possible types of the participant i. In one embodiment, there is an edge from the super node * to each of the standard nodes and there is an edge on every ordered pair of standard nodes. The edge from * to standard node ĉᵢ has weight −ĉᵢ(ϕ*(ĉᵢ, c₋ᵢ)), and the edge from standard node

$${\hat{c}}_{i} to {\hat{c}}_{i}^{′} has weight - {\hat{c}}_{i} ( {ϕ}^{★} ( {\hat{c}}_{i} , {c}_{- i} ) ) + {\hat{c}}_{i} ( {ϕ}^{★} ( {\hat{c}}_{i}^{′} , {c}_{- i} ) ) .$$

In one embodiment, constructing engine 201 constructs such a graph using various software tools which can include, but are not limited to, Ripjar®, Graphviz, Plotly®, NetworkX, Gephi, etc.

In operation 704, constructing engine 201 of central broker 104 determines the payment from the participant i to central broker 104 corresponding to the shortest path distance from the super node * to cᵢ, where cᵢ is the type declared by the participant i, and where ϕ*(c)∈argmin_{Φ}{Σᵢcᵢ(Φ)}.

As discussed above, in one embodiment, constructing engine 201 computes the shortest path distance from the super node * to cᵢ by finding a path from the super node * to cᵢ that minimizes the sum of the weights of its edges. In one embodiment, constructing engine utilizes Dijkstra's algorithm for finding such a shortest path distance.

In one embodiment, constructing engine 201 implements Dijkstra's algorithm using the following steps: (1) marking the ending vertex with a distance of zero, which is designated as the current vertex; (2) finding all vertices leading to the current vertex and calculating their distances to the end; (3) marking the current vertex as visited; and (4) marking the vertex with the smallest distance as the current vertex, and repeating from step 2.

Based on determining the payment from the participant i to central broker 104 using such a constructed graph, various desirable properties are guaranteed. For example, it is guaranteed that the optimal strategy of each participant i is to truthfully declare its type, which gives a clear course of action for the participant i as illustrated in FIGS. 3A-3B.

As shown in FIG. 3A, cloud providers 102 are represented by P₁, P₂, and P₃. Cloud buyers 101 are represented by B₁, B₂, and B₃. Each participant's value on the allocation (top value for cloud providers 102 and left numbers for cloud buyers 101) is shown in FIG. 3A. Furthermore, each participant's payment to central broker 104 (bottom value for cloud providers 102 and right numbers for cloud buyers 101) is shown in FIG. 3A. As illustrated in FIG. 3A, each participant's value of the allocation and their payment to central broker 104 add up to a nonnegative utility (measure of how much benefit a party receives or is expected to receive).

As illustrated in FIG. 3B, cloud provider P₁ could gain nothing even if such a cloud provider 102 declared a false type, in which case his payment to central broker 104 would increase accordingly as shown in element 301.

Another desirable property that is guaranteed based on determining the payment from the participant i to central broker 104 using such a constructed graph is that the tasks are allocated in a manner that the total cost of processing those tasks is minimized as illustrated in FIGS. 4A-4B.

Referring to FIG. 4A, FIG. 4A illustrates the cost/profit of each contract under the declaration between cloud providers 102 (identified as P₁, P₂, and P₃) and cloud buyers 101 (identified as B₁, B₂, and B₃). As shown in FIG. 4A, the cost/profit between cloud provider P₁ and cloud buyer B₁ is −2/+2. In another example, the cost/profit between cloud provider P₁ and cloud buyer B₂ is −2/+3 and so forth.

By determining the payment from the participant i to central broker 104 corresponding to the shortest path distance from the super node * to cᵢ, the total cost of processing the tasks is minimized as illustrated in FIG. 4B.

Referring to FIG. 4B, the efficient allocation of the tasks between cloud providers 102 and cloud buyers 101 has a maximum total value of 6. For instance, based on the cost/profit of the contracts between cloud provider P₁ and cloud buyers B₁, B₂, and B₃, the contract between cloud provider P₁ and cloud buyer B₂ has the maximum cost/profit as shown in FIG. 4B. In another example, based on the cost/profit of the contracts between cloud provider P₂ and cloud buyers B₁, B₂, and B₃, the contract between cloud provider P₂ and cloud buyer B₃ has the maximum cost/profit as shown in FIG. 4B. In a further example, based on the cost/profit of the contracts between cloud provider P₃ and cloud buyers B₁, B₂, and B₃, the contract between cloud provider P₃ and cloud buyer B₁ has the maximum cost/profit as shown in FIG. 4B. As further shown in FIG. 4B, the total cost among the cloud providers P₁, P₂, and P₃ equals −5; whereas, the total profit among the cloud buyers, B₁, B₂, and B₃ equals +11 thereby resulting in a maximum total value of 6.

Another desirable property that is guaranteed based on determining the payment from the participant i to central broker 104 using such a constructed graph is that the utility (measure of how much benefit a party receives or is expected to receive, which may correspond to payment received-cost) is nonnegative for every participant i as illustrated in FIG. 5.

Referring to FIG. 5, FIG. 5 is a graph illustrating the distribution of the participants' utility over random multi-cloud market instances. As shown in FIG. 5, such a utility is nonnegative for every participant i.

A further desirable property that is guaranteed based on determining the payment from the participant i to central broker 104 using such a constructed graph is that when a unique allocation minimizes the total cost (i.e., |argmin_{Φ}{Σᵢcᵢ(Φ)}|=1), the revenue of central broker 104 cannot be made larger without sacrificing the other desirable properties.

In operation 705, generating engine 202 of central broker 104 creates a multi-cloud environment with n cloud providers 102 and b cloud buyers 101 based on the allocation of the set of tasks, each of whom has m types, where n, b and m are positive integer values, as well as based on the payment between central broker 104 and cloud providers 102 and the payment between central broker 104 and cloud buyers 101. For example, generating engine 202 may create a multi-cloud environment consisting of cloud buyers 101A-101C and cloud providers 102A-102C in which the tasks, such as the tasks of cloud buyers 101A-101C are allocated to be handled by cloud providers 102A-102C. For instance, the tasks of cloud buyer 101A may be handled by cloud providers 102A and 102B, the tasks of cloud buyer 101B may be handled by cloud providers 102B and 102C, and the tasks of cloud buyer 101C may be handled by cloud provider 102A.

As stated above, generating engine 202 may utilize various software tools for creating a multi-cloud environment, including, but not limited to, IBM® Hybrid Cloud Mesh, Terraform®, Ansible®, Cloudify, Morpheus®, etc.

In this manner, a multi-cloud environment is created that is beneficial for all participants (e.g., cloud buyers 101, cloud providers 102) in the sense that all participants obtain a higher utility than in a single cloud market by solving the shortest path problem on a graph that only involves a linear number of nodes to determine the amount of payment among the relevant parties (e.g., cloud buyers 101, cloud providers 102) involving an allocation of tasks among the participants, while guaranteeing desirable properties. By determining such payment by solving the shortest path problem, a multi-cloud environment is established in a computationally efficient manner that can be applied to large multi-cloud markets.

Furthermore, the principles of the present disclosure improve the technology or technical field involving a multi-cloud environment.

As discussed above, multi-cloud is an infrastructure approach that includes a combination of two or more cloud platforms. These platforms may be public or private, although most multi-cloud environments are comprised of at least two different public cloud platforms. Multi-cloud can also (but not necessarily) include on-premise compute, networking, and storage that integrate and work together with the cloud services. Many organizations desire a multi-cloud approach to infrastructure because it addresses and helps eliminate some common challenges. For example, having more than one cloud platform allows organizations to take advantage of the unique features and capabilities of each cloud platform. For instance, one cloud platform might be optimized for application hosting while another cloud platform offers cost-effective, scalable space to store public archives, and so forth. With a multi-cloud approach, organizations overcome the limitations of vendor lock-in and can access all the different capabilities they need. Using a single-cloud approach, the cloud provider locks the cloud users to not only the features and capabilities of the cloud provider but also pricing and other factors, such as available services and tools. Another reason enterprises opt for multi-cloud is to comply with data sovereignty and regulations in specific geographic locations. Different regions and countries have different laws, so an organization might need to store customer data from one country, for example, on a cloud platform located there, while other customer data from another region is stored separately. Multi-cloud can also serve as an effective failover model which can help organizations retain data and keep operations running in the event of a cloud or connection failure. Having multiple copies and backups of critical data on different cloud platforms can mean faster recovery time and better business continuity if their main cloud platform goes down. Unfortunately, establishing a multi-cloud environment may result in direct economic losses to not only the cloud providers (provides on-demand, scalable computing resources, such as computing power, data storage, or applications over the Internet) but also to at least some of the cloud buyers (purchaser of computing resources provided by the cloud providers). For example, the cloud providers' prices in a multi-cloud environment may cause the cloud buyers to lose money as compared to the prices paid in the single-cloud environment (cloud buyer relies upon one cloud provider to provide computing resources). As a result, a multi-cloud environment does not necessarily benefit the relevant parties (e.g., cloud providers, cloud buyers), including cloud buyers, thereby lessening the incentive to establish a multi-cloud environment. Furthermore, in order to establish a multi-cloud environment that benefits relevant parties, information, including confidential information, such as information technology costs and the value of the information technology for the cloud buyers and cloud providers, needs to be obtained. Unfortunately, there is little incentive for the parties to disclose such confidential information. Currently, a process has been developed that establishes a multi-cloud environment that is beneficial to the relevant parties (e.g., cloud providers, cloud buyers) and inherently includes the incentives for the relevant parties to divulge their confidential information. However, such a process has high computational complexity and can only be applied to small multi-cloud markets that involve only a few participants.

Embodiments of the present disclosure improve such technology by receiving a declared type cᵢ from a participant i (e.g., cloud buyer, cloud provider) corresponding to cost parameters. In one embodiment, such a declared type cᵢ corresponds to a function that maps a set of tasks to a cost of processing the set of tasks by the participant i. For example, in a cloud environment, there is a set of cloud providers (also referred to herein as “sellers”), which is denoted by CP. In the scenario in which the participant i corresponds to the cloud buyer, each cloud provider cp∈CP has a set of computational resources it can provide to the cloud buyer to fulfill each of its tasks. For all cloud buyers cb∈CB, it is assumed that each of the cloud buyer's tasks can be implemented either on computational resources provided by one or more of the cloud providers cp∈CP, or on an internal computational infrastructure owned and operated by the cloud buyer. This represents the cost of processing the tasks by the participant i. Cloud buyers pay cloud providers for computational resources they use and have costs associated with the internal computational resources (cost of processing the tasks by the participant i). The efficient allocation of tasks, such as the tasks from the cloud buyers and cloud provider, is then determined, such as by solving an optimization problem, such as an Integer Linear Programming (ILP) problem. A task, as used herein, is an independent piece of work. For example, tasks for the cloud buyers could be data extraction, machine learning, etc. Tasks for the cloud providers could be storing, computing, etc. Such tasks require a set of resources to be utilized to perform such tasks. Allocation, as used herein, refers to a task of a particular participant (e.g., particular cloud buyer) being provided to a different participant (e.g., particular cloud provider) to be performed and handled. A graph of nodes and edges is then constructed that is utilized to determine payment among the participants involving the allocation of tasks among the participants, such as by computing the shortest path distance. In one embodiment, the constructed graph includes nodes and edges, where the nodes and edges are defined based on the costs of processing tasks by the participant i. In one embodiment, the nodes include a super node (designated as *) and standard nodes corresponding to the possible types of the participant i. In one embodiment, there is an edge from the super node * to each of the standard nodes and there is an edge on every ordered pair of standard nodes. In one embodiment, the edge from * to standard node ĉᵢ has weight—ĉᵢ(ϕ*(ĉᵢ, c₋ᵢ)), and the edge from standard node

$${\hat{c}}_{i} to {\hat{c}}_{i}^{′} has weight - {\hat{c}}_{i} ( {ϕ}^{★} ( {\hat{c}}_{i} , {c}_{- i} ) ) + {\hat{c}}_{i} ( {ϕ}^{★} ( {\hat{c}}_{i}^{′} , {c}_{- i} ) ) ,$$

where ϕ*(c)∈argmin_{Φ}{Σᵢcᵢ(Φ)}, and where cᵢ(Φ) denotes the cost of participant i to process the tasks allocated to i with allocation Φ. Payment from the participant i who has declared type cᵢ to the central broker is determined corresponding to the shortest path distance from the super node * to cᵢ. In one embodiment, the shortest path distance is computed from the super node * to cᵢ by finding a path from the super node * to cᵢ that minimizes the sum of the weights of its edges. In one embodiment, Dijkstra's algorithm is utilized for finding such a shortest path distance. A multi-cloud environment with cloud providers and cloud buyers is then created based on the allocation of the set of tasks as well as based on the payment between the central broker and the cloud providers and the payment between the central broker and the cloud buyers. In this manner, a multi-cloud environment is created in a computationally efficient manner that can be applied to large multi-cloud markets. Furthermore, in this manner, there is an improvement in the technical field involving a multi-cloud environment.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for establishing a multi-cloud environment, the method comprising;
receiving a declared type cᵢ from a participant i corresponding to cost parameters;
constructing a graph of nodes and edges, wherein the nodes comprise a super node and standard nodes corresponding to possible types of the participant i; and
determining payment from the participant i to a central broker involving an allocation of tasks among participants corresponding to a shortest path distance from the super node to the cᵢ.

2. The method as recited in claim 1 further comprising:
obtaining the allocation of tasks among the participants by solving an optimization problem.

3. The method as recited in claim 2 further comprising:
creating a multi-cloud environment with n cloud providers and b cloud buyers based on the allocation of tasks among the participants, each of whom has m types, where n, b and m are positive integer values, and based on the determined payment from the participant i to the central broker.

4. The method as recited in claim 1, wherein the participant corresponds to a cloud buyer.

5. The method as recited in claim 1, wherein the participant corresponds to a cloud provider.

6. The method as recited in claim 1, wherein the allocation minimizes a total cost of processing the tasks.

7. The method as recited in claim 1, wherein the graph contains a linear number of the nodes, wherein there is an edge on every ordered pair of the standard nodes, wherein there is an edge from the super node to every standard node.

8. A computer program product for establishing a multi-cloud environment, the computer program product comprising one or more computer readable storage mediums having program code embodied therewith, the program code comprising programming instructions for:
receiving a declared type cᵢ from a participant i corresponding to cost parameters;
constructing a graph of nodes and edges, wherein the nodes comprise a super node and standard nodes corresponding to possible types of the participant i; and
determining payment from the participant i to a central broker involving an allocation of tasks among participants corresponding to a shortest path distance from the super node to the cᵢ.

9. The computer program product as recited in claim 8, wherein the program code further comprises the programming instructions for:
obtaining the allocation of tasks among the participants by solving an optimization problem.

10. The computer program product as recited in claim 9, wherein the program code further comprises the programming instructions for:
creating a multi-cloud environment with n cloud providers and b cloud buyers based on the allocation of tasks among the participants, each of whom has m types, where n, b and m are positive integer values, and based on the determined payment from the participant i to the central broker.

11. The computer program product as recited in claim 8, wherein the participant corresponds to a cloud buyer.

12. The computer program product as recited in claim 8, wherein the participant corresponds to a cloud provider.

13. The computer program product as recited in claim 8, wherein the allocation minimizes a total cost of processing the tasks.

14. The computer program product as recited in claim 8, wherein the graph contains a linear number of the nodes, wherein there is an edge on every ordered pair of the standard nodes, wherein there is an edge from the super node to every standard node.

15. A system, comprising:
a memory for storing a computer program for establishing a multi-cloud environment; and
a processor connected to the memory, wherein the processor is configured to execute program instructions of the computer program comprising:
receiving a declared type cᵢ from a participant i corresponding to cost parameters;
constructing a graph of nodes and edges, wherein the nodes comprise a super node and standard nodes corresponding to possible types of the participant i; and
determining payment from the participant i to a central broker involving an allocation of tasks among participants corresponding to a shortest path distance from the super node to the cᵢ.

16. The system as recited in claim 15, wherein the program instructions of the computer program further comprise:
obtaining the allocation of tasks among the participants by solving an optimization problem.

17. The system as recited in claim 16, wherein the program instructions of the computer program further comprise:
creating a multi-cloud environment with n cloud providers and b cloud buyers based on the allocation of tasks among the participants, each of whom has m types, where n, b and m are positive integer values, and based on the determined payment from the participant i to the central broker.

18. The system as recited in claim 15, wherein the participant corresponds to a cloud buyer.

19. The system as recited in claim 15, wherein the participant corresponds to a cloud provider.

20. The system as recited in claim 15, wherein the allocation minimizes a total cost of processing the tasks.
